(19) United States
(12) Patent Application Publication
(10) Pub. No.: US 2011/0225642 A1
(43) Pub. Date: Sep. 15, 2011

(54) CONFIGURATION OF COMPUTER AND COMMUNICATION SYSTEMS RESPONSIVE TO PHYSICAL PRESENCE OF A USER AT A SITE

(75) Inventor: Mohanakrishnan G. Gopalakrishna, Thornton, CO (US)

(73) Assignee: Avaya Inc., Basking Ridge, NJ (US)

(21) Appl. No.: 12/722,788

(22) Filed: Mar. 12, 2010

(51) Int. Cl. G06F 15/177; G06F 21/20

(52) U.S. Cl. 726/9; 709/221; 726/5

(57) ABSTRACT

At a site that has spaces for users, a computer system receives a reservation for one of the users for one of the spaces. A user detection apparatus detects physical presence of the user at the site and transfers a presence indication. The computer system processes the presence indication to authorize the user and identify the reservation. In response, the computer system configures a communication system to route communications directed to the user to a communication device in the reserved space, configures a user computer in the reserved space to access a data network system based on a user profile for the user, and configures a graphic display in the reserved space to display an image associated with the one user.

### TECHNICAL BACKGROUND

The work force is becoming increasingly nomadic with many workers operating at multiple locations around the world. Typically, these workers require the support of various communication and computer systems. In some cases, support personnel at a given location configure computers and telephones for the workers before they arrive. In other cases, the workers themselves configure these systems once they arrive at the location.

### OVERVIEW

At a site that has spaces for users, a computer system receives a reservation for one of the users for one of the spaces. A user detection apparatus detects physical presence of the user at the site and transfers a presence indication. The computer system processes the presence indication to authorize the user and identify the reservation. In response, the computer system configures a communication system to route communications directed to the user to a communication device in the reserved space, configures a user computer in the reserved space to access a data network system based on a user profile for the user, and configures a graphic display in the reserved space to display an image associated with the one user.

### BRIEF DESCRIPTION OF THE DRAWINGS

FIG. 1 illustrates a site configuration system that configures computer and communication systems at a site in an exemplary embodiment.

FIG. 2 illustrates the operation of a site configuration system in an exemplary embodiment.

FIG. 3 illustrates the operation of a site configuration system in an exemplary embodiment.

FIG. 4 illustrates a site configuration system that configures computer and communication systems at an office site in an exemplary embodiment.

FIG. 5 illustrates the operation of a site configuration system in an exemplary embodiment.

FIG. 6 illustrates a computer system that configures computer and communication systems at a site in an exemplary embodiment.

### DETAILED DESCRIPTION

The following description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described below, but only by the following claims and their equivalents.

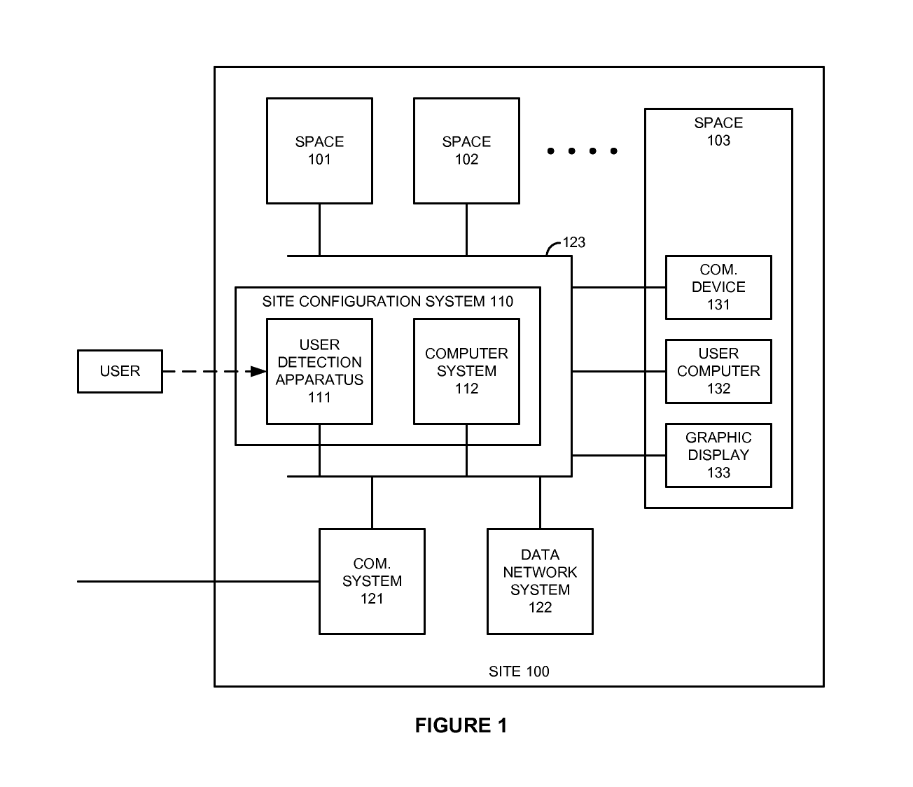

FIG. 1 illustrates site configuration system 110 that configures computer and communication systems at site 100 in an exemplary embodiment. Site 100 includes spaces 101-103, site configuration system 110, communication system 121, data network system 122, and communication network 123. Space 103 contains communication device 131, user computer 132, and graphic display 133. Spaces 101-102 would include similar equipment. Site configuration system 110 comprises user detection apparatus 111 and computer system 112.

Spaces 101-103 comprise discrete geographic areas that may be occupied by a user. Spaces 101-103 could be offices, rooms, workstations, cubicles, labs, kiosks or some other user areas—including combinations thereof. Site 100 may include additional spaces having similar equipment.

User detection apparatus 111 comprises a device that identifies the physical presence of individual persons. User detection apparatus 111 could be a security card reader, biometric scanner, voice detection system, password verification computer, near-field communication device, or some other identification apparatus. User detection apparatus 111 is operationally coupled to communication network 123.

Computer system 112 comprises processing circuitry, memory, software, and a user interface. Computer system 112 could be a personal computer, server, mainframe, or some other processing system. Computer system 112 may be a discrete device or be distributed across multiple devices. Some portions of computer system 112 may not be physically present ay site 100. Computer system 112 is operationally coupled to communication network 123.

Communication system 121 comprises equipment that exchanges user communications among user communication devices and external systems. Communication system 121 could be a switch, private branch exchange, router, server, or some other communication network element—including combinations thereof. Communication system 121 is operationally coupled to communication network 123 and to an external communication link.

Data network system 122 comprises equipment that stores and provides restricted access to data. Data network system 122 could be a data server, storage area network, secure database, or some other data storage and serving system. Data network system 122 is operationally coupled to communication network 123.

Communication network 123 comprises network elements and links that exchange communications between various devices and systems at site 100. Communication network 123 could be a Local Area Network (LAN), Wide Area Network (WAN), intranet, enterprise communication system, or some other system to transfer communication signals. Communication network 123 may be a single system or a combination of overlay systems.

Communication device 131 comprises a transceiver that exchanges user communications between an individual person and communication network 123. Communication device 131 could be a telephone, computer, internet appliance, or some other communication interface. Communication device 131 is operationally coupled to communication network 123.

User computer 132 comprises processing circuitry, memory, software, and a user interface, such as a display screen, mouse, keyboard, and the like. User computer 132 could be a personal computer, laptop, tablet computer, or some other processing system. User computer 132 may be a discrete device or be distributed across multiple devices. Some portions of user computer 132 may not be physically located in space 103. User computer 132 is operationally coupled to communication network 123.

Although communication device 131 and user computer 132 may be discrete devices, they may also be partially or totally integrated together. For example, communication device 131 could comprise a headset that plugs into user computer 132, as well as, Voice Over Internet Protocol (VOIP) software and processing circuitry resident in user computer 132.

Graphic display 133 comprises a display screen and communication interface. Graphic display 133 could be a digital photograph frame, Liquid Crystal Display (LCD), Cathode Ray Tube (CRT), plasma display, Light Emitting Diode (LED) display, or some other interface for receiving and rendering graphical images. Graphic display 133 is coupled to communication network 123. It should be understood that graphic display 133 is a separate and distinct system from user computer 132, or any components of user computer 132 capable of providing display functionality. For example, user computer 134, as discussed above, may include a display screen. This display screen would be a different display than graphic display 133. Rather, graphic display 133 would be included in space 103 in addition to any display screen that may accompany user computer 132.

In operation, a user has a reservation for space 103 that is stored in computer system 112. The reservation specifies various computer and communication needs for the user, such as the need for telephony communications, data access, and the like. The reservation may include user data, such as an email address, telephone number, social network handle, user ID, password, and an image selected by the user. Alternatively, the reservation may include a user identifier that can be used to access this information.

When the user arrives at site 100, user detection system 111 detects the physical presence of the user and transfers a corresponding presence indication for the user to computer system 112. To facilitate presence detection, the user might swipe a security card, place their hand on a biometric scanner, enter a password, or perform some other task. Computer system 112 processes the presence indication to authorize the user and retrieve the reservation. Authorization entails comparing data from the indication to an authentication database. For example, retina scan data from apparatus 111 could be compared to data previously collected from the user.

If the user is authorized, computer system 112 processes the reservation to configure communication device 131, user computer 132, and graphic display 133 for operation by the user. The configuration may also include transferring control instructions to communication system 121 and data network system 122. In addition, computer system 112 typically provides an authorization indication proximate to user detection apparatus 111 for use by security systems and/or personnel.

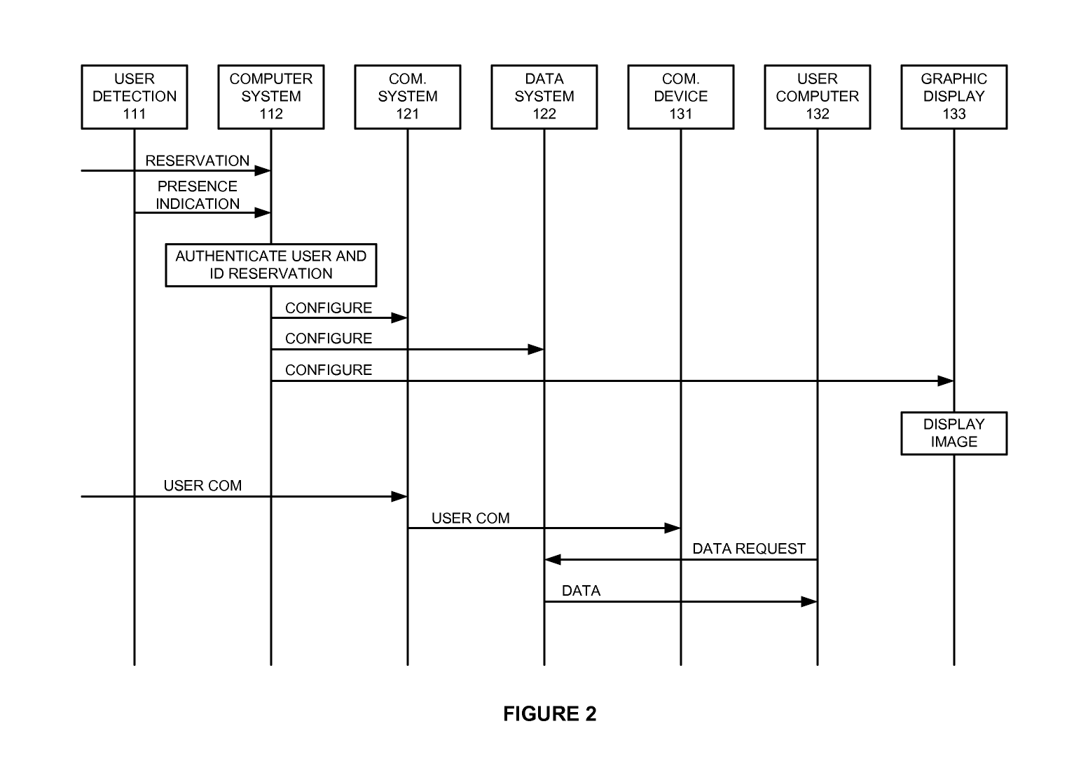

FIG. 2 illustrates the operation of site configuration system 110 in an exemplary embodiment. Computer system 112 receives and stores a reservation for the user for space 103. The reservation could be remotely entered by the user or entered on the user's behalf. When the user subsequently arrives at site 100, user detection apparatus 111 detects the user and transfers a presence indication to computer system 112. Computer system 112 authorizes the user and identifies the reservation.

In response to identifying the reservation, computer system 112 transfers configuration instructions to communication system 121. The configuration instructions direct communication system 121 to route communications for the user to communication device 131 based on an identifier for the user. For example, the instructions might cause communication system 121 to bind the user's telephone number to a network address for communication device 131.

In response to identifying the reservation, computer system 112 transfers configuration instructions to data network system 122. The configuration instructions direct data network system 122 to provide access to data in accord with the user's profile based on an identifier for the user. For example, the instructions might cause data network system 122 to allow user computer 132 to download restricted technical files, but to deny all access to restricted financial information.

In response to identifying the reservation, computer system 112 also transfers configuration instructions to graphic display 133. The configuration instructions direct graphic display 133 to render a user-selected image. For example, the configuration instructions may include a digital photograph of the user's family for display in space 103.

Subsequently, communication system 121 receives a user communication from an external system that is directed to the user. The user communication could be a voice call, text message, or some other communication signal. In response to the configuration, communication system 121 transfers the user communication to communication device 131 in space 103. In addition, the user operates user computer 132 to request restricted data from data network system 122. In response to the configuration, data network system 122 transfers the requested data to user computer 132 in space 103.

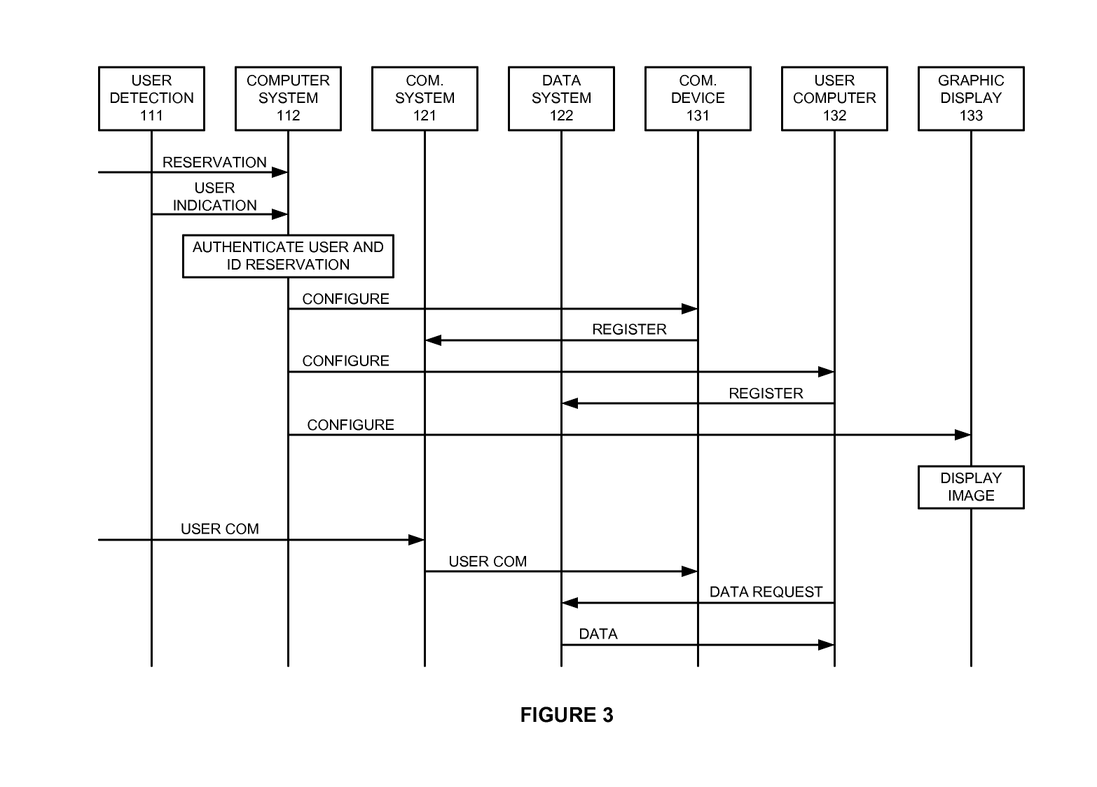

FIG. 3 illustrates the operation of site configuration system 110 in another exemplary embodiment. Computer system 112 receives and stores a reservation for the user for space 103. When the user subsequently arrives at site 100, user detection apparatus 111 detects the user and transfers a presence indication to computer system 112. Computer system 112 authorizes the user and retrieves the user's reservation. In addition, computer system 112 typically provides an authorization indication proximate to user detection apparatus 111 for use by security systems and/or personnel.

In response to retrieving the reservation, computer system 112 transfers configuration instructions to communication device 131. The configuration instructions direct communication device 131 to register with communication system 121. In response to the registration, communication system 121 will direct communications that are directed to the user to communication device 131. For example, the instructions might cause communication device 131 to associate its own network address with the user's telephone number in communication system 121.

In response to retrieving the reservation, computer system 112 also transfers configuration instructions to user computer 132 to initiate data network access. The configuration instructions direct user computer 132 to register with data network system 122 using the user's network ID and password. Data network system 122 will then serve up restricted data to user computer 132 upon request in accord with the user's profile.

In response to retrieving the reservation, computer system 112 also transfers configuration instructions to graphic display 133. The configuration instructions direct graphic display 133 to render a user-selected image. For example, the configuration instructions may include a digital photograph of the user's family for display in space 103.

Subsequently, communication system 121 receives a user communication from an external system that is directed to the user. The user communication could be a voice call, text message, or some other communication signal. In response to the configuration, communication system 121 transfers the user communication to communication device 131 in space 103. In addition, the user operates user computer 132 to request restricted data from data network system 122. In response to the configuration, data network system 122 transfers the requested data to user computer 132 in space 103.

FIGS. 2-3 illustrate various techniques for site configuration system 110 to configure computer and communication systems for the user in response to the user's reservation and the user's physical presence. There are various ways of combining these techniques to form additional embodiments. For example, the technique for configuring data access on FIG. 2 could be combined with the technique for configuring communications on FIG. 3.

In some embodiments, an additional layer of security could be provided by issuing the user a temporary password upon authorization. For example, computer system 112 could provide the password for display to the user proximate to user detection apparatus 111. Computer system 112 would also direct user computer 132 to provide only a welcome screen via its display screen for password input without providing access to any configured services. The user would simply input the password to unlock user computer 132 and access all of the configured services.

In addition, the user's reservation would typically indicate a termination time point. At that time point, site configuration system 110 would de-configure the computer and communication systems using a reciprocal process. In some examples, site configuration system 110 could de-configure the computer and communication systems on a daily basis, and reconfigure them when and if the user returns the next day.

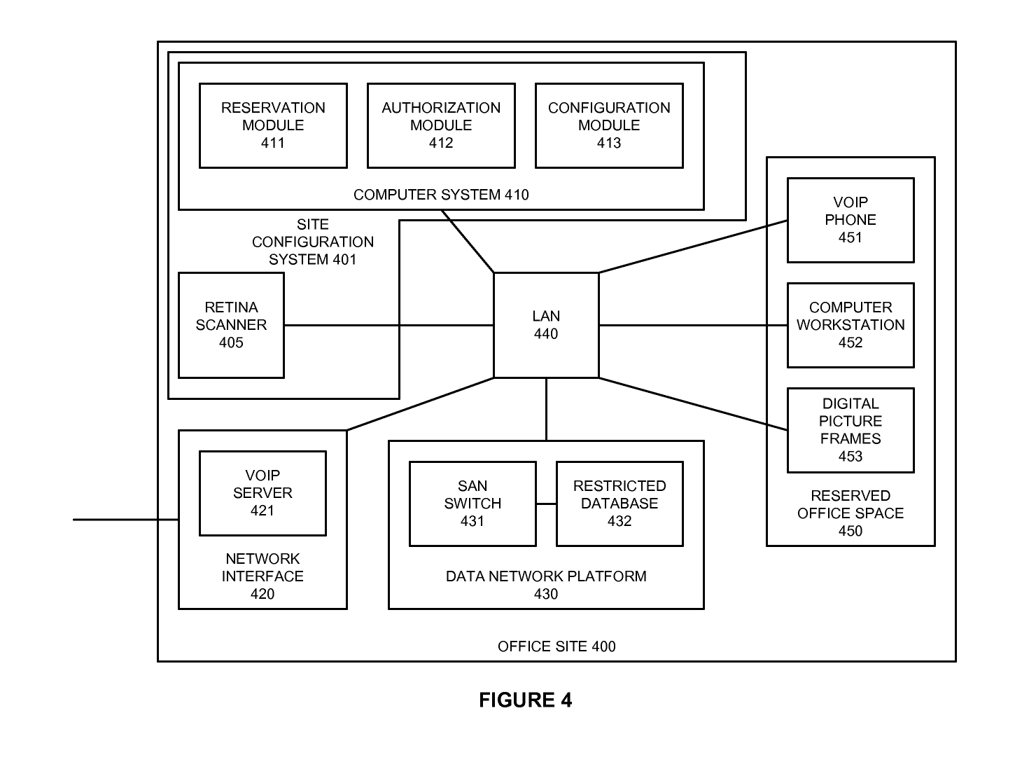

FIG. 4 illustrates office site 400, which includes site configuration system 401 for configuring computer and communication systems within office site 400, in an exemplary embodiment. Office site 400 includes network interface 420, data network platform 430, LAN 440, and reserved office space 450. Site configuration system 401 comprises retina scanner 405 and computer system 410. Computer system 410 includes reservation module 411, authorization module 412, and configuration module 413. Network interface 420 includes VOIP server 421. Data network platform 430 includes Storage Area Network (SAN) switch 431 and restricted database 432. Reserved office space 450 includes VOIP phone 451, computer workstation 452, and digital picture frames 453. Office site 400 includes additional offices with similar equipment that are not shown for clarity.

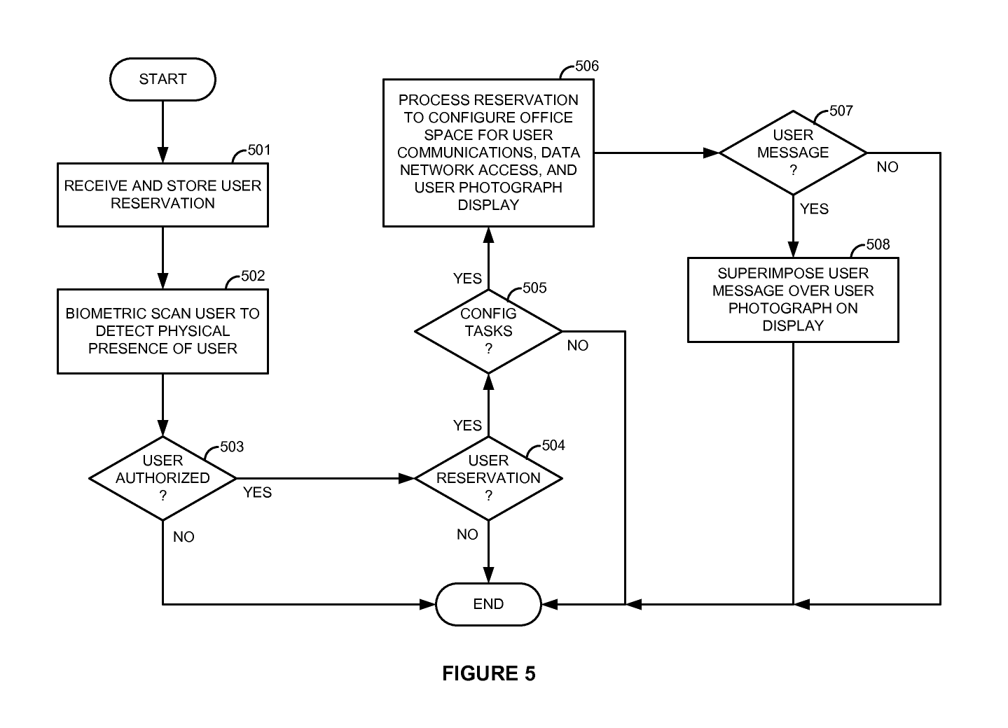

FIG. 5 illustrates the operation of site configuration system 401 in an exemplary embodiment. The operation starts with reservation module 411 receiving and storing a user reservation for office space 450 (501). The reservation includes the user's telephone number, email address, video subscription ID, data network ID, Virtual Private Network (VPN) ID, various digital photographs selected by the user, and various associated passwords. In this example, the user logs-in to reservation module 411 from a remote location to establish the reservation.

When the user arrives at office site 400, retina scanner 405 biometrically scans the user to detect their physical presence and provides the scanning results to authorization module 412 (502). Authorization module 412 compares the scan to previously collected retina data to determine if the user is authorized (503). If the user is not authorized (503), then the operation ends and the user is typically denied access to office site 400.

If the user is authorized (503), then reservation module 411 determines if the user has a reservation (504). If the user does not have a reservation (504), then the operation ends, although the user typically obtains access to office site 400. If the user has a reservation (504), then configuration module 413 determines if there are any configuration tasks for reserved office space 450 (505). If there are no configuration tasks (505), then the operation ends, although the user typically obtains access to reserved office space 450.

If there are configuration tasks (505), then configuration module 413 processes the reservation to configure reserved office space 450 for the user (506). Configuration module 413 directs VOIP phone 451 to register its IP address and the user's telephone number with VOIP server 421 using the user's VOIP password. Thus, the user has live access to voice calling and any voice mail when they enter reserved office space 450. Configuration module 413 directs computer workstation 452 to log-in to the user's email account using the user's email address and password. Thus, the user has live access to their updated and current email inbox when they enter reserved office space 450. Configuration module 413 directs computer workstation 452 to log-in to the user's video account using the user's video subscription ID and password. Thus, the user has live access to their streaming video service, such as a business or news feed, when they enter reserved office space 450. Configuration module 413 directs computer workstation 452 to log-in to SAN switch 431 using the user's data network ID and password. Thus, the user has live access to restricted database 432 (according to their user profile) when they enter reserved office space 450. Configuration module 413 directs computer workstation 452 to log-in to a remote VPN using the user's VPN ID and password. Thus, the user has live access to remote data and services over their VPN when they enter reserved office space 450. Finally, configuration module 413 directs digital picture frames 453 to display the digital photographs selected by the user. These personal picture displays provide a level of comfort to the user, but they also prevent the accidental use of the wrong office by the user or by others.

Configuration system 413 also determines if there are any special messages for the user (507). These messages could be provided by the user as a reminder (“say hello to Mr. Smith”), by the user's supervisor (“immediately activate system X and report to my office”), or by someone else with access to computer system 410. If there are no special messages (507), then the operation ends. If there is a special message (507), then configuration system 413 drives digital picture frames 453 to superimpose the message over the digital pictures (508). This may entail fading the digital pictures and blinking the superimposed message. Although similar messaging could be handled through an email, voice mail, or text message, the above technique provides better notice as the user enters reserved office space 450. Typically, configuration system 413 places an icon on the desktop of computer workstation 452 allowing the user to clear the superimposed message from digital picture frames 453.

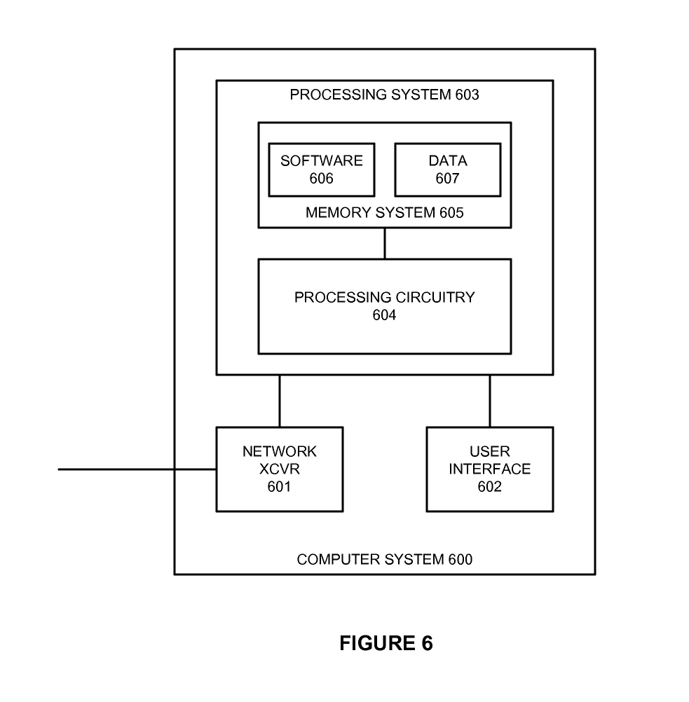

FIG. 6 illustrates computer system 600 that configures computer and communication systems at a site in an exemplary embodiment. Computer system 600 is an example of computer systems 112 and 410, although systems 112 and 410 may use alternative configurations. Computer system 600 could be a discrete system, a distributed system, and/or could be integrated into other systems.

Computer system 600 comprises network transceiver 601, user interface 602, and processing system 603. Processing system 603 comprises processing circuitry 604 and memory system 605 that stores software 606 and data 607. Data 607 includes reservation data, authorization data, and configuration information. Processing system 603 is linked to transceiver 601 and user interface 602. Computer system 600 may include other well-known components that are not shown for clarity, such as additional communication interfaces, user interfaces, databases, processors, enclosures, power supply, and the like.

Network transceiver 601 comprises a communication port, signal processing circuitry, software, and/or some other communication components. Network transceiver 601 may include an antenna and Radio Frequency (RF) circuitry if wireless communication is used. Network transceiver 601 may use various communication protocols, such as time division multiplex, internet, Ethernet, wireless, or some other communication format—including combinations thereof. Network transceiver 601 receives reservations and presence indications. Network transceiver 601 transfers configuration instructions.

User interface 602 includes components that facilitate human interaction with processing system 603. Examples of user interface 602 include graphic displays, keys, switches, touchpad, mouse, touch screen, speakers, microphone, camera, and the like.

Processing circuitry 604 comprises microprocessor and other circuitry that retrieves and executes software 606 from memory system 605. Memory system 605 comprises a non-transitory, computer-readable storage medium, such as a disk drive, flash drive, data storage circuitry, or some other memory apparatus. Memory system 605 could be a single device or be distributed across multiple devices. Processing circuitry 604 is typically mounted on one or more circuit boards that may also hold memory system 605 and portions of transceiver 601 and user interface 602.

Software 606 comprises computer programs, firmware, or some other form of computer-readable processing instructions. Software 606 may include an operating system, utilities, drivers, network interfaces, applications, or some other type of software. When executed by processing circuitry 604, software 606 directs processing system 603 to operate computer system 600 as described herein for computer systems 112 and 410. In particular, software 606 directs processing system 603 to receive reservations, authorize users, and configure reserved spaces as described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a site configuration system wherein a site has a plurality of spaces for a plurality of users, the method comprising:
in a computer system, receiving a reservation for one of the spaces for one of the users;
in a user detection apparatus, detecting physical presence of the one user at the site and transferring a presence indication that the one user is physically present at the site; and
in the computer system, processing the presence indication to authorize the one user and identify the reservation, and in response, configuring a communication system to route communications directed to the one user to a communication device in a reserved space, configuring a user computer in the reserved space to access a data network system based on a user profile for the one user, and configuring a graphic display in the reserved space to display an image associated with the one user.

2. The method of claim 1 wherein configuring the communication system comprises directing the communication device to register with the communication system using a user identifier for the one user.

3. The method of claim 1 wherein configuring the communication system comprises directing the communication system to associate the communication device with a user identifier for the one user.

4. The method of claim 1 wherein configuring the user computer comprises directing the user computer to register with the data network system using a user identifier for the one user.

5. The method of claim 1 wherein configuring the user computer comprises directing the data network system to associate the user computer with a user identifier for the one user.

6. The method of claim 1 wherein configuring the graphic display comprises directing the graphic display to display a digital photograph previously selected by the one user.

7. The method of claim 1 further comprising receiving a message for the one user and direct the graphic display to display the message superimposed over the image.

8. The method of claim 1 wherein configuring the user computer comprises directing an email application in the user computer to log-in to an email account for the one user.

9. The method of claim 1 wherein detecting the physical presence of the one user comprises electromagnetically reading a security card.

10. The method of claim 1 wherein detecting the physical presence of the one user comprises biometrically sensing the one user.

11. A site configuration system wherein a site has a plurality of spaces for a plurality of users, the site configuration system comprising:
a computer system configured to receive a reservation for one of the spaces for one of the users;
a user detection apparatus configured to detect physical presence of the one user at the site and transfer a presence indication that the one user is physically present at the site; and
the computer system further configured to process the presence indication to authorize the one user and identify the reservation, and in response, to configure a communication system to route communications directed to the one user to a communication device in a reserved space, to configure a user computer in the reserved space to access a data network system based on a user profile for the one user, and to configure a graphic display in the reserved space to display an image associated with the one user.

12. The site configuration system of claim 11 wherein the computer system is configured to direct the communication device to register with the communication system using a user identifier for the one user.

13. The site configuration system of claim 11 wherein the computer system is configured to direct the communication system to associate the communication device with a user identifier for the one user.

14. The site configuration system of claim 11 wherein the computer system is configured to direct the user computer to register with the data network system using a user identifier for the one user.

15. The site configuration system of claim 11 wherein the computer system is configured to direct the data network system to associate the user computer with a user identifier for the one user.

16. The site configuration system of claim 11 wherein the computer system is configured to direct the graphic display to display a digital photograph previously selected by the one user.

17. The site configuration system of claim 11 wherein the computer system is configured to receive a message for the one user and direct the graphic display to display the message superimposed over the image.

18. The site configuration system of claim 11 wherein the computer system is configured to direct an email application in the user computer to log-in to an email account for the one user.

19. The site configuration system of claim 11 wherein user identification apparatus is configured to electromagnetically read a security card.

20. The site configuration system of claim 11 wherein user identification apparatus is configured to biometrically sense the one user.
